(19) United States
(12) Patent Application Publication
(10) Pub. No.: US 2015/0040469 A1
(43) Pub. Date: Feb. 12, 2015

(54) Inducement of Root Formation

(71) Applicant: Ryan William Liesche, Spokane, WA (US)

(72) Inventor: Ryan William Liesche, Spokane, WA (US)

(21) Appl. No.: 13/964,426

(22) Filed: Aug. 12, 2013

(51) Int. Cl. A01G 1/00

(52) U.S. Cl. CPC A01G 1/001; A01G 1/00
USPC 47/5.5

(57) ABSTRACT

Root-growth stimulating compounds are applied to plants to stimulate growth of roots on the stem of a plant for air layering. The root-growth stimulating compounds may be applied by wrapping part of the plant with a tape that includes the root-growth stimulating compounds. The tape may include a gel layer that is impregnated or coated with the root-growth stimulating compounds. The root-growth compound may additionally or alternatively be applied to a plant by affixing a clamshell-type device around part of the plant. The device may hold a porous material containing the root-growth stimulating compounds in contact with the plant. Both the tape and the clamshell-type device may block light from reaching the covered portion of the plant thereby causing chlorosis.

### BACKGROUND

Air layering is a method in which many different types of plants including woody, herbaceous, and hard to root plants can be propagated. The basic principle involves making new plants from old ones by encouraging new roots on a stem while the stem is still attached to the parent plant. Once roots have developed, the stem is cut below the new roots and the part with the new roots, a cutting propagule, is placed in soil, a hydroponic solution, etc. to grow as a new plant independent from the parent plant. Air layering is used by both hobbyists and commercial producers of cut flowers and agricultural crops.

The traditional method for this process involves manually wounding the stem of the parent plant to expose the inner tissues of the stem, using a brush to applying a powdered or gelatinous rooting hormone to the affected area, wrapping with water-soaked peat or sphagnum moss, and finally wrapping with plastic to prevent moisture loss. String may be used to secure the sphagnum moss and electricians tape may be used to secure the plastic to the stem. Once the roots have begun to grow from the stem, the stem is cut just below the treated area, the plastic is removed, and the new plant is potted.

For some types of plants, such as woody plants, the air layering process is combined with etiolation. Etiolation is the process in which the selected stem or shoot is covered with an opaque or semi-transparent cover to induce chlorosis (i.e., loss of green color). The purpose of etiolation is to create new, soft growth that is more conducive to air layering. Other adaptations to the air layering process include defoliation of the cutting, hedging, and/or ring barking.

### SUMMARY

Root growth is promoted in plants by techniques that can lead to generation of a cutting propagule. Multiple features that are advantageous for promoting root growth through air layering may be combined in a convenient tape or a clamshell-type apparatus. A specialized multi-layer tape may include a gel layer that contains root-growth stimulating compounds such as rooting hormones. The gel layer may be covered by a removable, protective layer to prevent the gel layer from exposure to air during storage. The gel layer may be placed above a porous layer that can provide a place for the additional root growth to occur. The porous layer may be covered by an opaque or semi-opaque layer that blocks light thereby encouraging chlorosis.

A piece of the tape of appropriate length may be wrapped around the stem of a plant in single step. Components of the tape may be made from biodegradable materials so that the root tape can be left in place when the cutting propagule is planted.

Similarly, the clamshell-type apparatus may contain replaceable pieces of porous material, such as foam, that can be impregnated with root-growth stimulating compounds and held in contact with the stem of a plant by closing the clamshell-type apparatus around the stem. The clamshell-type apparatus may be made of a rigid or semi-rigid material, such as plastic, that can block light from reaching the stem. Once roots have begun to grow, the clamshell-type apparatus may be removed and reused by fitting it with new pieces of porous material.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows a cut-away view of multilayered tape for inducing root growth.

FIG. 2 shows a roll of the multilayered tape of FIG. 1 with a protective layer partially removed and the tape applied around a plant.

FIG. 3 shows the tape applied to a region of a plant.

FIG. 4 shows planting a cutting propagule without removing the tape.

FIG. 5 shows top views in both open and closed configurations of a clamshell-type apparatus for inducing root growth.

FIG. 6 is a flow diagram of an illustrative process for creating a cutting propagule from a parent plant.

### DETAILED DESCRIPTION

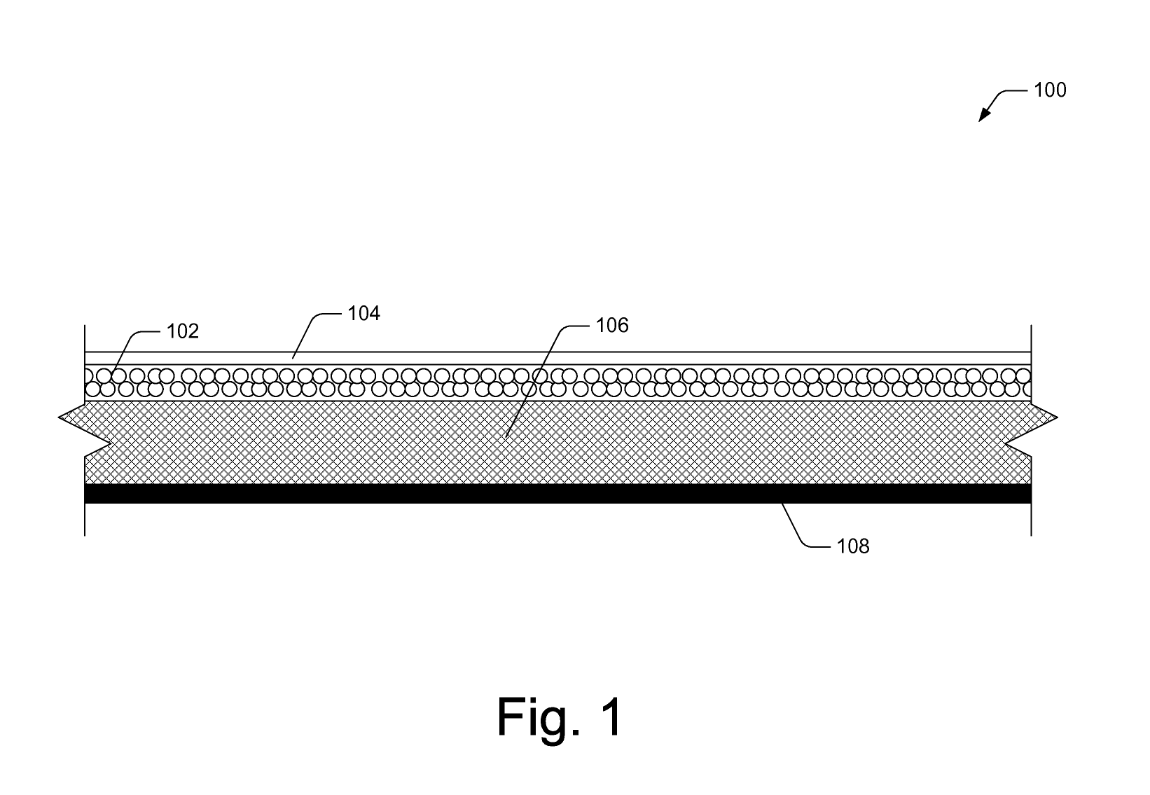

FIG. 1 shows a cut-away view 100 of a multi-layered tape that may be applied to a plant to induce root growth as part of the air layering method of plant propagation. The tape may be any size, shape, or dimension such as a long strip (e.g., wound into a roll like a roll of conventional tape), in short strips, bands, or as squares, circles, or irregular shaped patches. For the sake of convenience this multi-layered tape for inducing a root formation is referred to as “root tape” herein.

A gel layer 102 of the root tape may contain one or more root-growth stimulating compounds. The gel layer 102 may be formed from an aqueous gel (e.g., agarose, gelatin, cellulose, polyethelene glycol, etc.) or oil-based gel (e.g., petroleum jelly, propylene glycol, glycerin, etc.). The root-growth stimulating compound may be a natural or synthetic plant hormone including, but not limited to, indole-3-acetic acid (IAA), indole-3-butyric acid (IBA), 1-naphthaleneacetic acid (NAA), 4-chloroindole-3-acetic acid (4-CI-IAA), α-naphthalene acetic acid (α-NAA), and/or 2,4-dichlorophenoxyacetic acid (2,4-D)). The gel layer 102 may have the root-growth stimulating compound mixed throughout the gel or the surface of the gel may be coated with the root-growth stimulating compound with or without mixing the compound throughout all of the gel.

The gel layer 102 may also include other compounds such as fungicides, antibiotics, bacteriophages, plant nutrients, minerals, vitamins, and/or amino acids. The fungicides may be synthetic or natural and may include cinnamaldehyde, neem oil, jojoba oil, phthalimides such as Captan® (3aR,7aS)-2-[(trichloromethyl)sulfanyl]-3a,4,7,7a-tetrahydro-1H-isoindole-1,3(2H)-dione), and the like. Each of these other compounds may also be applied to the surface of the gel and/or mixed throughout the gel. The amount of hormones, fungicides, antibodies, phages, nutrients, vitamins, minerals, and/or amino acids may be modified for different applications such as by making specific mixtures for different types of plants and for different air layering environments.

Varying the type and relative amount of compounds and/or symbionts included when making the root tape may allows similar tape be used for many applications other than promoting root growth and plant propagation. For example, the tapes and clamshell-type apparatus discussed in this disclosure may also be used to cover a joint created by grafting two different plants together and promote successful grafting, cover a wounded or disease portion of a plant and assist with wound healing or disease control, and the like.

A removable, protective layer 104 may cover the gel layer 102 when the root tape is not in use. The removable, protective layer 104 may be peeled away from the remainder of the root tape (i.e., like the backing on double-sided adhesive tape) at the time of use to expose the gel layer 102 for application to the plant. The removable, protective layer 104 may protect compounds in the gel layer 102 from exposure to air and may protect an aqueous gel from desiccation. Exposure to oxygen can degrade some root growth hormones. Thus, the removable, protective layer 104 may allow the root tape to be stored. In contrast, once a conventional container of a rooting compound is opened, the rooting compound must be used rapidly or else it degrades due to exposure to oxygen. However, by removing the protective layer 104 from a section of root tape that is to be applied to a plant, the problem of exposure to air is minimized because the unused portions remain protected by the removable, protective layer 104. The removable, protective layer 104 may be formed from a compound that inhibits passage of moisture and oxygen such as cellophane, foil, an impermeable membrane, or other material. The removable, protective layer 104 may also prevent the root tape from adhering to itself when wound into a roll.

The root tape may include a porous layer 106 beneath the gel layer 102. The porous layer 106 may create a mechanical cushion for the portion of the plant that is covered by the root tape, create air spaces, and make room for the roots to grow. When applied to a plant, roots will grow through the gel layer first before reaching the porous layer 106. In some implementations, the porous layer 106 may be between ⅛ inch and ¼ inch thick. The porous layer 106 may be created from natural fibers (e.g., cotton gauze), rooting foam, a polymer matrix, injection molded foam, or other porous material. The polymer matrix may be formed from any type of suitable polymer. To prevent or minimize absorption of the gel layer 102 into the porous layer 106, the porous layer 106 may be of a hydrophobic or non-absorbent material. If the porous layer 106 is formed with a biodegradable material, such as a biodegradable polymer, the porous layer 106 may degrade when the root tape is placed in soil.

The porous layer 106 may be impregnated with plant nutrients, hormones, vitamins, beneficial symbionts, fungi, microbes, other beneficial organisms, amino acids, phages, antibodies, fungicides, and/or minerals. The addition of these and other compounds and organisms to the porous layer 106 may protect fledgling roots from pathogens, provide nutrients, minerals, vitamins, amino acids, and promote colonization of beneficial symbionts. The porous layer 106 may include the same or different compounds than the gel layer 102 and may include the same or different amounts of the same compounds that are included in the gel layer 102.

A moisture barrier layer 108 may prevent moisture from leaving the root tape. When wrapped around the stem of a plant, the moisture barrier layer 108 is the outermost layer of the root tape. The moisture barrier layer 108 may fully or partially block passage of moisture. Moisture within the root tape may come from the plant, water from an aqueous gel in the gel layer 102, and/or moisture within the porous layer 106. The moisture barrier 108 may comprise a one-way barrier that allows moistures in but not out or two-way barrier that blocks all movement of moisture.

The moisture barrier 108 may also be made of an opaque or semi-transparent material that blocks or reduces the amount of light reaching the other layers of the root tape and the stem of the plant. Blocking or reducing light from reaching the covered part of the plant stem may promote etiolation thereby promoting root growth. The moisture barrier 108 may be made of a material, such as a biodegradable polymer, that allows roots to pass through. Thus, the root tape may be left in place when a cutting propagule is transferred to the soil because the roots will be able to pass through the moisture barrier 108 and continue growing. In some implementations, the moisture barrier 108 may be made of a material that completely blocks the passage of moisture and/or prevents the roots from growing through the moisture barrier 108.

The side of the moisture barrier 108 that is not adjacent to the porous layer 106 may be coated with a tacky or adhesive coating to facilitate self-adhesion and to hold the root tape in place when wrapped around a plant stem. In other implementations, the gel layer 104 may include an adhesive so that the root tape can stick to a plant and to itself.

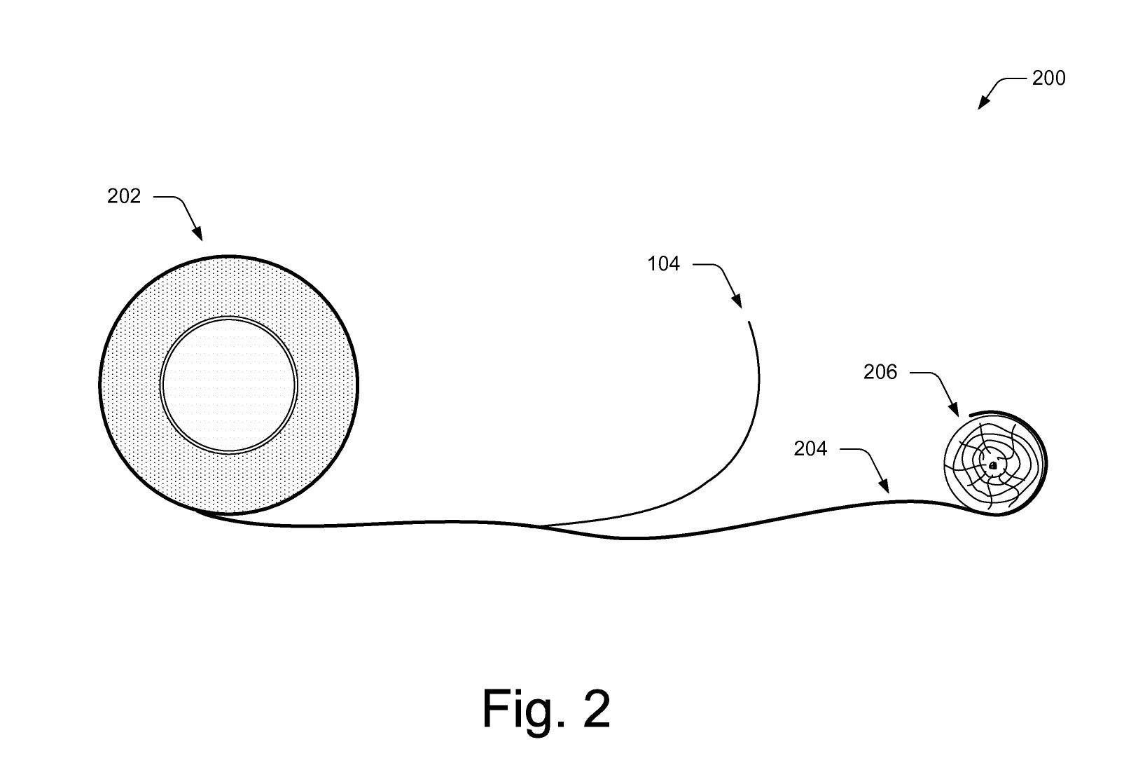

FIG. 2 shows a schematic 200 of a roll 202 root tape being applied to a plant. When rolled, the moisture barrier 108 is the outermost layer of the role 202 of root tape. As the root tape is peeled off of the role 202, the removable, protective layer 104 may be removed from the root tape exposing the remaining layers 204 of the root tape. Alternatively, the removable, protective layer 104 may be omitted and the moisture barrier 108 may serve as a protective layer for the adjacent wrap of the root tape when formed as a roll of tape. The root tape, without the removable, protective layer 104 is wrapped around the outside of a plant stem 206. Referring to the orientation of the tape shown in FIG. 1, the gel layer 102 is in direct contact with the outer surface of the plant stem 206 and the subsequent layers are located outside of the gel layer 102. When wrapped once around the plant stem 206, adhesive on the outside of the moisture barrier 108 may adhere to the gel layer 102 of a subsequent wrap up the root tape. Thus, the root tape may be self-adhesive and remain wrapped around the plant stem 206 without the use of additional tape, string, or the like.

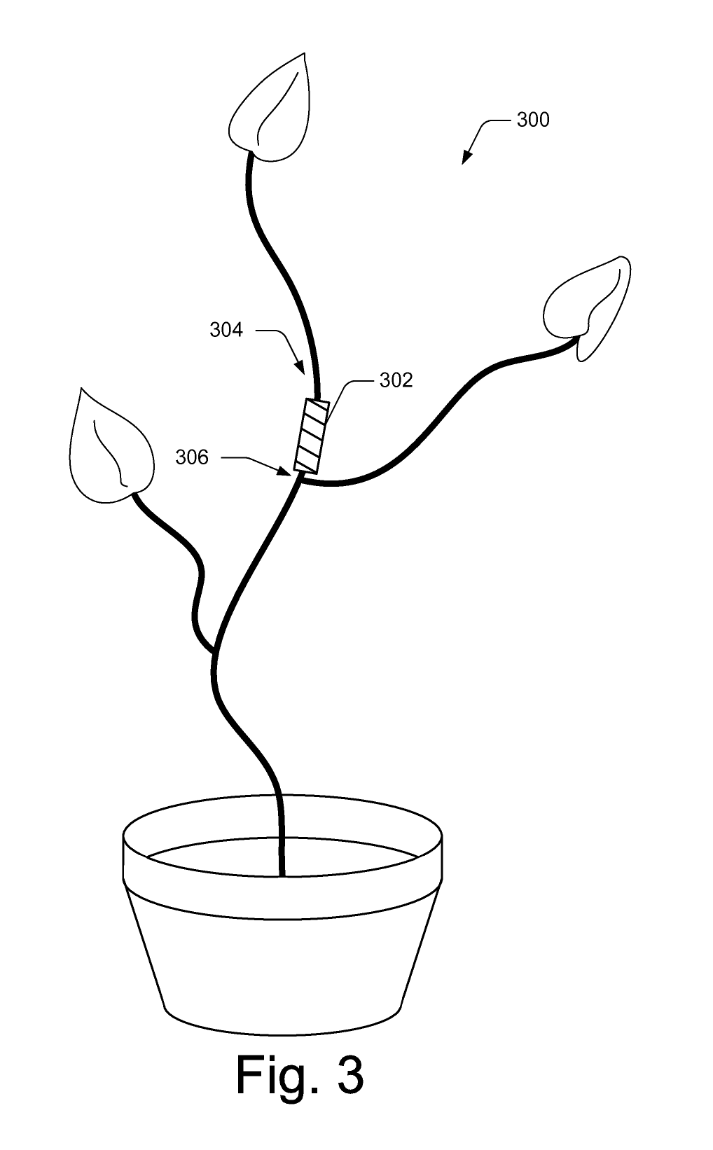

FIG. 3 shows a plant 300 with multiple wraps 302 of root tape surrounding the stem 304 of the plant 300. A user may easily vary the size of the region of the plant 300 covered by the root tape by making additional wraps around the stem 304 of the plant. The wraps 302 of the root tape may be positioned so that cutting at a location 306 beneath the wraps 302, closer to the roots of the plant 300, will produce an appropriate cutting propagule.

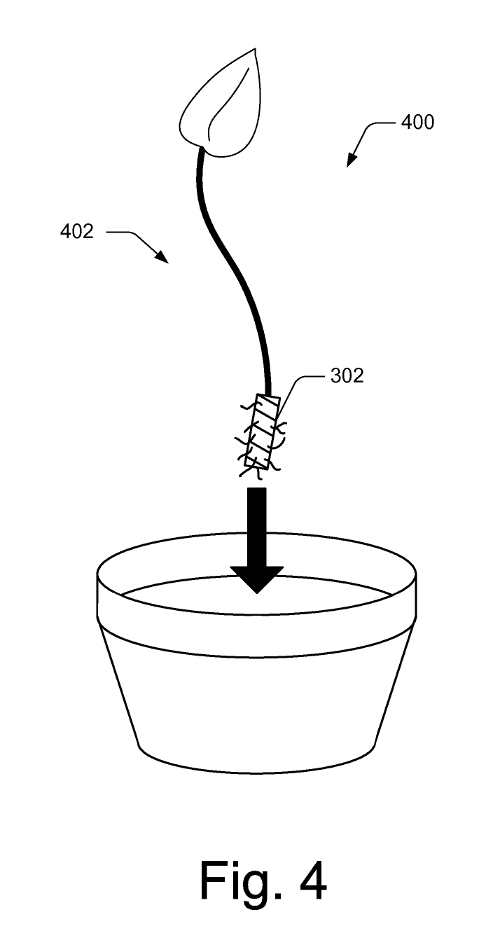

FIG. 4 shows the cutting propagule 400 created by cutting the plant 300 at the location 306 beneath the wraps 302 of the root tape. Newly formed roots 402 may grow from the stem of the plant 300 outward through the root tape. It may be easier for the roots 402 to penetrate the moisture barrier 108 if the moisture barrier 108 is permeable or semi-permeable to water. However, a permeable or semi-permeable moisture barrier 108 may need periodic wetting until the cutting propagule 400 is planted. Use of an oil-based gel in the gel layer 102 may reduce or eliminate the need for periodic wetting when used in combination with a permeable moisture barrier 108. The oil-based gel may also serve to block water loss from the plant. Thus, some implementations of the root tape may combine an oil-based gel layer 102 with a semi-permeable or permeable moisture barrier 108. A non-permeable moisture barrier 108 may retain enough moisture to do without periodic wetting, but a non-permeable a moisture barrier 108 may also be more difficult for growing roots to pass through.

The cutting propagule 400 may be potted thereby creating a new plant from the parent plant 300. When the various layers of the root tape are biodegradable and the moisture barrier 108 allows the roots 402 to grow through, the wraps 302 of the root tape may be left on the cutting propagule 400 when the cutting propagule 400 is planted. Leaving the root tape in place minimizes or eliminates tearing of roots. Thus, root tape can provide the advantage of encouraging root formation for air layering with material that is not removed from the cutting propagule 400. This may reduce the amount of labor needed to propagate additional plants through air layering as well as protect the newly formed roots.

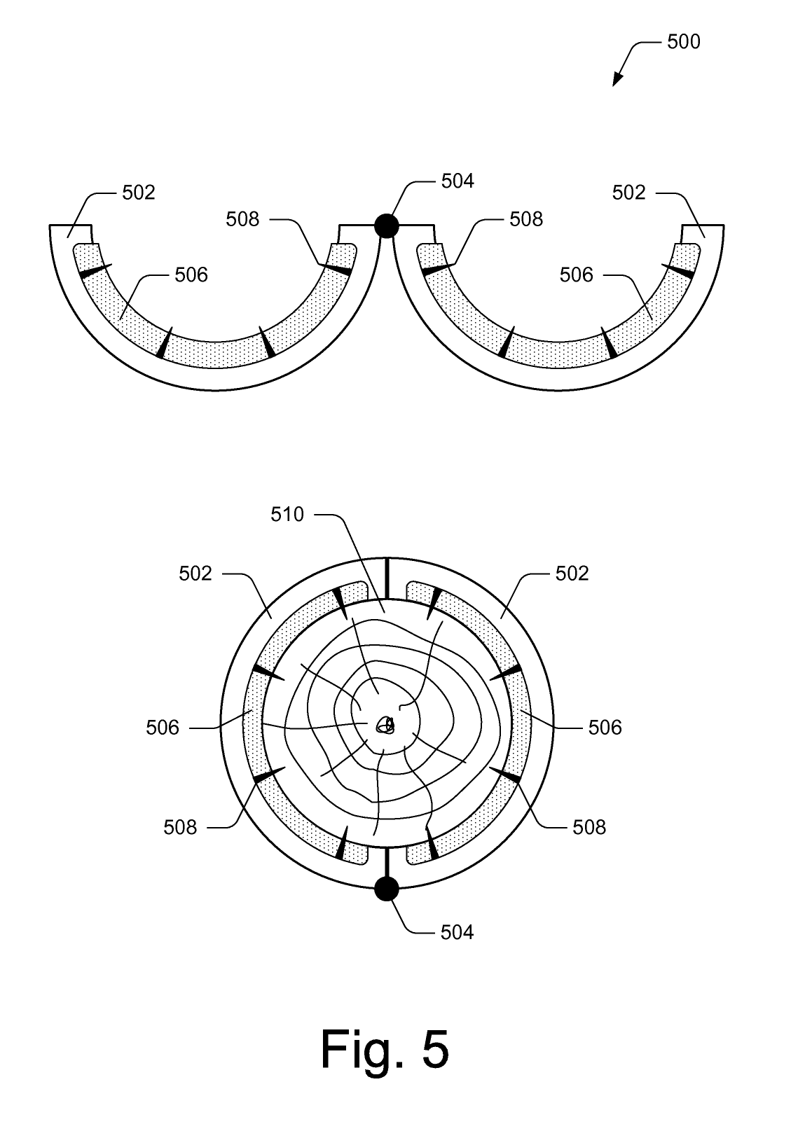

FIG. 5 shows top views 500 of a clamshell-shaped apparatus for air layering in an open and in a closed configuration. The clamshell-shaped apparatus may include two housings 502 formed from rigid or semi-rigid material, such as plastic, wood, metal, etc., and connected by a hinge 504. Each of the two housings 502 may have a semi-circular curve so that when closed by pivoting the hinge 504, the clamshell-shaped apparatus forms a ring. The hinge 504 may be implemented as any type of mechanism that allows the two housings 502 to swing relative to one another. For example, a flexible piece of plastic connecting the two housings 502 may function as the hinge 504. The housings 502 may contain a porous material 506. The porous material 506 may be cotton gauze, rooting foam, a polymer matrix, injection molded foam, or other material. The porous material 506 may be impregnated or soaked in a solution containing root-growth stimulating compounds, hormone, antibiotics, fungicides, vitamins, plant nutrients, beneficial symbionts, fungi, microbes, other beneficial organisms, amino acids, phages, minerals, or a combination thereof.

The clamshell-shaped apparatus may also include spikes 508 on the inside of one or both housings 502 to wound a stem 510 of a plant when the clamshell-shaped apparatus is closed around the stem 510. The spikes 508 may be made of the same or a different material than the housings 502. The length of the spikes 508 may be sufficient to extend through the porous material 506 and penetrate into the stem 510 when the clamshell-shaped apparatus is closed. The wound created by the spikes 508 may be sufficient to expose meristematic cells of the plant.

In some implementations, the root tape described above and shown in FIGS. 1 and 2 may also include spikes similar to the spikes 508 show in FIG. 5. The spikes on the root tape may extend from the moisture barrier 108 through the porous layer 106 and possible also through the gel layer 102. The spikes on the root tape may be contiguous with the moisture barrier 108 and formed from the same piece of material. The spikes may also be formed from a different material and attached to the moisture barrier 108 with an adhesive or held in place by the various layers of the root tape.

The porous material 506 may be removable and the housings 502 and the hinge 504 of the clamshell-shaped apparatus may be reusable many times. However, new roots growing from the stem 510 may grow into the porous material 506 causing the porous material 506 to be replaced each time the clamshell-shaped apparatus is reused. The mixture of root-growth stimulating compounds and other compounds applied to the porous material 506 may be changed depending on the particular plant and application. For example, prepackaged pieces of the porous material 506 may be prepared for different applications and inserted into the housings 502 shortly before use.

The housings 502 may be made from a material that blocks root growth. Therefore, the housings 502 and the hinge 504 may be opened and removed from the stem 510 before a cutting propagule is placed into soil. The housings 502 may also be made of non-porous material that prevents moisture from escaping from the stem 510 or from the porous material 506 while the clamshell-shaped apparatus is attached to the plant. Furthermore, the housings 502 may be made of an opaque or light-blocking material that causes etiolation of the stem 510.

The clamshell-shaped apparatus may be made in multiple sizes and configurations for different types of plants. The diameter of the space enclosed by the housings 502 may be determined based on the diameter of the stem 510 for which the clamshell-shaped apparatus is intended to be used. The presence of spikes 508 and, if present, the number of spikes 508 may also be varied in different configurations of the clamshell-shaped apparatus. In some implementations, the clamshell-shaped apparatus may include an attachment mechanism opposite the hinge 504 to keep the clamshell-shaped apparatus close around the circumference of the stem 510. The attachment mechanism may be a clasp, a snap, an adjustable mechanism capable of accommodating a range of stem diameters, or the like. In other implementations, the hinge 504 may function to maintain the clamshell-shaped apparatus in a closed position. In yet further implementations, the spikes 508 may be sufficient to retain the clamshell-shaped apparatus in place.

By combining the appropriate hormones, nutrients, moisture and a mechanism for wounding the stem 510 (i.e., the spikes 508) into one apparatus, the clamshell-shaped apparatus combines several previously separate steps into the single action of closing the clamshell-shaped apparatus around an appropriate location on the stem 510 of a plant. Fastening the attachment mechanism may provide mechanical force to drive the spikes into the stem 510 of the plant. For example, the attachment mechanism may include a twist or ratchet feature to tightly close the clamshell-shaped apparatus around the stem 510. Use of this type of clamshell-shaped apparatus may enable a person to perform air layering on plants more rapidly than with traditional techniques. This may be particularly advantageous in high-volume commercial plant propagation settings. Additionally, the ability to insert pieces of the porous material 506 prepared in advance with the appropriate root-growth stimulating compounds, nutrients, and the like provides a higher level of convenience and predictability that may be desirable for hobbyists.

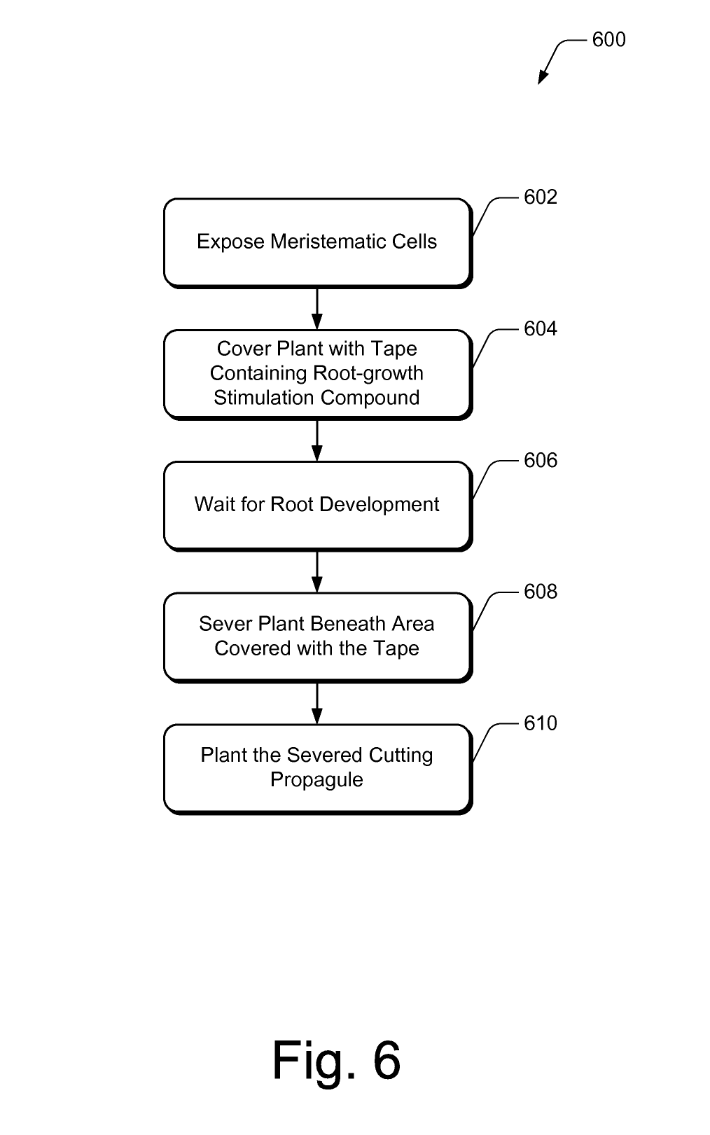

FIG. 6 is an illustrative process 600 for inducing root growth with the tape described above. Process 600 may also be modified to use the clamshell-type apparatus described above.

At 602, a plant is wounded to expose meristematic cells. Scratching, cutting, or disturbing the outer tissue layers of the parent plant stem may promote root growth. For some herbaceous plants, it may be possible to apply root-growth stimulating compounds to the stem of the plant and induce root growth without wounding the plant. However, for some woody plants it may be difficult to induce root growth without removing a substantial amount of woody outer tissue.

At 604, the wounded area of the plant is covered with root tape. As discussed above, the root tape may comprise multiple layers and include a root-growth stimulating compound. A gel layer of the root tape that contains the root-growth stimulating compound is placed in contact with the wounded area of the plant so that the root-growth stimulating compound may reach the meristematic cells within the plant stem. In implementations in which the root tape includes a removable, protective layer, that layer is removed before the root tape is applied to the plant so that the gel layer is exposed. The root tape may be wrapped firmly around the stem of the plant so that the root tape remains in place while the roots grow. In implementations in which the root tape includes an adhesive, the adhesive may be used to adhere the root tape to itself and/or to the stem of the plant.

At 606, a period of time is allowed to pass while new roots develop. The root tape remains wrapped around the stem of the plant during this time. The waiting may last from between about four days to six weeks or longer depending on parent plant type. The waiting time is generally longer for woody plants and shorter for herbaceous/succulent plants. During this time the newly forming roots may grow into the root tape.

At 608, the plant is severed beneath the area covered with the multilayered root tape. This creates a cutting propagule that has the start of a root system. Any green material below the new roots (i.e., the stem of the parent plant) may be removed. The outer layer of the root tape which may be a moisture barrier that is non- or semi-permeable to water may be removed to expose the roots for planting. The moisture barrier may be removed in implementations in which the moisture barrier is non-permeable to water and does not allow the roots to grow through. In other implementations in which the roots can grow through a moisture barrier (e.g., a semi-permeable moisture barrier) the cutting propagule may be planted with the moisture barrier still attached. In some implementations for some plant types, the waiting period at 606 may be omitted and the plant may be severed shortly after application of the root tape.

At 610, the cutting propagule is planted in a medium (e.g., soil, hydroponic solution, etc.) and in a fashion that is appropriate for the plant. A light-permeable humidity tent or moisture barrier may be placed around the new cutting to prevent excess moisture loss until the incipient root system becomes established at which time the barrier may be removed.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A multilayered tape adapted for inducing root formation in plants comprising:
an opaque moisture barrier; and
a gel layer containing a root-growth stimulating compound adjacent to the opaque moisture barrier.

2. The tape of claim 1, wherein the opaque moisture barrier is semi-permeable to moisture.

3. The tape of claim 1, wherein the opaque moisture barrier comprises a biodegradable plastic.

4. The tape of claim 1, wherein a side of the opaque moisture barrier facing away from the gel layer includes an adhesive coating.

5. The tape of claim 1, wherein the gel layer comprises a water-based gel.

6. The tape of claim 1, wherein the gel layer comprises an oil-based gel.

7. The tape of claim 1, wherein the root-growth stimulating compound comprises indole-3-acetic acid (IAA), indole-3-butyric acid (IBA), 1-naphthaleneacetic acid (NAA), 4-chloroindole-3-acetic acid (4-CI-IAA), α-naphthalene acetic acid (α-NAA), or 2,4-dichlorophenoxyacetic acid (2,4-D).

8. The tape of claim 1, wherein the gel layer contains at least one of a fungicide, an antibiotic, or a plant nutrient.

9. The tape of claim 1, further comprising a removable protective layer situated on an opposite surface of the gel layer than the opaque moisture barrier.

10. The tape of claim 9, wherein the removable protective layer reduces the exposure of the gel layer to oxygen.

11. The tape of claim 1, further comprising a porous layer between the moisture barrier and the gel layer.

12. The tape of claim 11, wherein the porous layer contains the gel layer.

13. The tape of claim 11, wherein the porous layer comprises rooting foam.

14. The tape of claim 11, wherein the porous layer comprises a biodegradable polymer matrix.

15. The tape of claim 11, wherein the porous layer comprises cotton gauze.

16. A method of inducing root formation in a plant comprising:
covering an area of a plant with a multilayered tape comprising a gel layer containing a root-growth stimulating compound placed in contact with the area of the plant and an opaque moisture barrier covering the gel layer and inhibiting desiccation of the gel layer.

17. The method of claim 16, further comprising exposing meristematic cells on the area of the plant before covering the area with the multilayered tape.

18. The method of claim 16, further comprising severing the plant beneath the area of the plant covered with the multilayered tape to separate a cutting propagule from the remainder of the plant.

19. The method of claim 18, further comprising waiting a period of time sufficient for root development to begin prior to the severing.

20. The method of claim 18, further comprising planting the cutting propagule while maintaining the multilayered tape in contact with the area of the plant.

21. An apparatus for inducing root growth in plants comprising:
a light-blocking ridged or semi-ridged housing configured to encircle substantially all of the circumference of a region of a plant; and
a porous material impregnated with a root-growth stimulating compound, the porous material held in contact with the region of the plant by the housing.

22. The apparatus of claim 21, wherein the housing comprises two pieces connected by a hinge, each of the two pieces having a semi-circular curve configured to encircle the region of the plant when the two pieces of the housing are pivoted together about the hinge.

23. The apparatus of claim 21, wherein the housing comprises one or more spikes situated on the inside of the housing so that the one or more spikes wound the region of the plant when the housing is closed around the circumference of the plant.
